(19) United States
(12) Patent Application Publication
(10) Pub. No.: US 2015/0046796 A1
(43) Pub. Date: Feb. 12, 2015

(54) PAGE FORMATION METHOD AND ELECTRONIC DEVICE SUPPORTING THE METHOD

(71) Applicant: Samsung Electronics Co., Ltd., Suwon-si (KR)

(72) Inventors: Yusic KIM, Suwon-si (KR); Jungah SEUNG, Guri-si (KR)

(21) Appl. No.: 14/449,789

(22) Filed: Aug. 1, 2014

(30) Foreign Application Priority Data
Aug. 6, 2013 (KR) 10-2013-0092952

(51) Int. Cl. G06F 17/21

(52) U.S. Cl. CPC G06F 17/212
USPC 715/247

(57) ABSTRACT

An apparatus and method for a page formation are provided. In the method, an electronic device outputs a content arrangement region and a content provision region having one or more contents contained therein. The electronic device assigns at least one of the contents contained in the content provision region to the content arrangement region, and forms a page by arranging the at least one content assigned to the content arrangement region according to a predefined size.

### CROSS-REFERENCE TO RELATED APPLICATION(S)

This application claims the benefit under 35 U.S.C. §119(a) of a Korean patent application filed on Aug. 6, 2013 in the Korean Intellectual Property Office and assigned Serial number 10-2013-0092952, the entire disclosure of which is hereby incorporated by reference.

### TECHNICAL FIELD

The present disclosure relates to technology of a page formation for an electronic device.

### BACKGROUND

Electronic devices typically allow for installation of a desired application that supports a particular function. For example, electronic devices may offer a function for creation of a document.

However, a typical function to create a document in an electronic device requires satisfying a specific standard supported by each application, thus causing difficulty in creating or editing a document. For example, when a user desires to create a page with a lot of contents, it is required to resize respective individual contents to meet a page size. Further, such resized contents may be often arranged at positions regardless of a user's desire.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide technology for a simplified and flexible arrangement of contents.

Another aspect of the present disclosure is to provide effective arrangement, adjustment and browsing of contents while offering the uniformity of layout to documents or pages.

In accordance with an aspect of the present disclosure, a page formation method is provided. The page formation method includes outputting a content arrangement region and a content provision region having one or more contents contained therein, assigning at least one of the contents contained in the content provision region to the content arrangement region, and forming a page by arranging the at least one content assigned to the content arrangement region according to a predefined size.

In accordance with another aspect of the present disclosure, an electronic device for supporting a page formation is provided. The electronic device includes a display module configured to output a content arrangement region and a content provision region having one or more contents contained therein, and a control module configured to assign at least one of the contents contained in the content provision region to the content arrangement region in response to an input event, and to form a page by arranging the at least one content assigned to the content arrangement region according to a predefined size.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating a configuration of an electronic device according to an embodiment of the present disclosure;

FIG. 2 is a block diagram illustrating a configuration of an electronic device according to another embodiment of the present disclosure;

FIG. 3 is a flow diagram illustrating a method for operating an electronic device in connection with formation of a page according to an embodiment of the present disclosure;

FIG. 4 is a schematic diagram illustrating formation of a page according to an embodiment of the present disclosure;

FIG. 5 is a schematic diagram illustrating a layout of a page according to an embodiment of the present disclosure;

FIG. 6 is a schematic diagram illustrating formation of a diary page according to an embodiment of the present disclosure;

FIG. 7 is a schematic diagram illustrating formation of a word page according to an embodiment of the present disclosure; and

FIG. 8 is a schematic diagram illustrating formation of an e-book page according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a page” includes reference to one or more of such pages.

In this disclosure, an electronic device may be a device that involves a communication function. For example, an electronic device may be a smart phone, a tablet Personal Computer (PC), a mobile phone, a video phone, an e-book reader, a desktop PC, a laptop PC, a netbook computer, a Personal Digital Assistant (PDA), a Portable Multimedia Player (PMP), a digital camera, a wearable device, a smart white appliance (e.g., a refrigerator, an air conditioner, a vacuum cleaner, an artificial intelligence robot, a TV, a Digital Video Disk (DVD) player, audio equipment, an oven, a microwave, a washing machine, an air cleaner, an electronic picture frame, etc.), a medical device (e.g., Magnetic Resonance Angiography (MRA), Magnetic Resonance Imaging (MRI), Computed Tomography (CT), ultrasonography, etc.), a navigation device, a Global Positioning System (GPS) receiver, an Event Data Recorder (EDR), an Flight Data Recorder (FDR), a set-top box, a TV box (e.g., Samsung HomeSync™, Apple TV™, Google TV™, etc.), an electronic dictionary, a car infotainment device, electronic equipment for a ship (e.g., a marine navigation system, a gyrocompass, etc.), avionics, security equipment, electronic clothes, a camcorder, a game console, a Head-Mounted Display (HMD), a flat panel display device, an electronic album, furniture or part of a building or construction having a communication function, an electronic board, an electronic signature receiving device, a projector, or any combination thereof. As well understood by those skilled in the art, the above-mentioned electronic devices are exemplary only and not to be considered as a limitation of this disclosure.

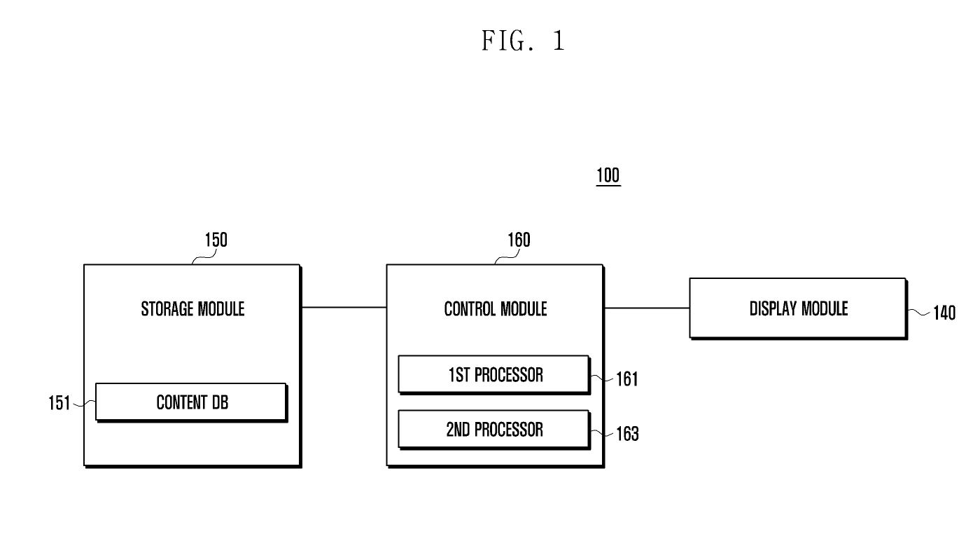

FIG. 1 is a block diagram illustrating a configuration of an electronic device according to an embodiment of the present disclosure.

Referring to FIG. 1, an electronic device 100 may include a display module 140, a storage module 150, and a control module 160.

The electronic device 100 has the ability to create a page by selectively arranging contents stored in a content DB 151 of the storage module 150 in response to an input signal.

The display module 140 may include a touch screen and generate an input signal associated with the arrangement and/or editing of contents. The display module 140 may deliver a touch-based input signal to the control module 160. Further, the display module 140 may output various screens associated with the formation of a page. For example, the display module 140 may output a screen that contains at least one page or document therein. Additionally, the display module 140 may output a page editor suitable for the formation of a specific page and also output various screens associated with such a page editor. For example, the display module 140 may output a content arrangement region and a content provision region. In this case, the display module 140 may deliver a touch event generated at such a region to the control module 160.

The storage module 150 may store programs and data associated with the operation of the electronic device 100. For example, the storage module 150 may store an operating system suitable for the electronic device 100. Further, the storage module 150 may store text, audio, or video data generated during the operation of the electronic device 100. For example, the storage module 150 may include the content Database (DB) 151 in connection with the formation of a page.

The content DB 151 may store text contents, audio contents, and/or video contents. Such contents stored in the content DB 151 may be inputted at the time of design of the electronic device 100 or received from any external entity through a communication function of the electronic device 100. Further, such contents may be generated through an input function of the electronic device 100. These contents may be retrieved and used in connection with the formation of a page.

The control module 160 may control the processing and delivery of signals associated with the operation of the electronic device 100. In an embodiment, the control module 160 may include a first processor 161 and a second processor 163 in connection with the formation of a page.

The first processor 161 may perform a procedure for processing the output of at least one page or for processing a content arrangement region associated with the creation of a new page or the editing of an existing page. For example, the first processor 161 may control the output of a screen for selecting at least one page in response to an input signal generated at the display module 140. Additionally, when an input signal associated with the creation of a new page or the editing of an existing page is received, the first processor 161 may control the display module 140 to output a page editor. At this time, the first processor 161 may control a procedure for processing a content arrangement region. For example, the first processor 161 may control the output of a content arrangement reserve region associated with the creation of a new page, the output of a content arrangement preparation region for arranging at least one content on a new page, or the output of a content arrangement display region on which the type and number of at least one content is displayed.

The first processor 161 may control arranging selected contents in a selected page in response to a request for transferring at least one of contents arranged in a content provision region. In this operation, the first processor 161 may control displaying the type and number of contents arranged in a selected page. Additionally, the first processor 161 may store the arrangement order of contents and, according to this order, may automatically form a page. In this operation, the first processor 161 may change the size of a page, depending on the size and number of contents.

The first processor 161 may support a change in the order of contents. For example, the first processor 161 may offer information about the order of contents. In response to an input signal associated with a change in the order of contents, the first processor 161 may change information about the order of contents and store the changed information. Based on such changed information, the first processor 161 may control the formation of a new page. In this operation, the first processor 161 may support the deletion of selected content and the insertion of new content.

The second processor 163 may perform a procedure for offering at least one of contents. In response to a request of the first processor 161, the second processor 163 may retrieve contents stored in the content DB 151 of the storage module 150. The second processor 163 may classify at least one of contents stored in the content DB 151 according to types or categories. For example, the second processor 163 may divide contents into text, media, charts, tables, and the like, and output each content provision region by the divided contents. Alternatively, the second processor 163 may offer a content provision region in which text, media, charts and tables are mixed.

The second processor 163 may control displaying such contents in a content provision region in the form of icons having a given size. In this case, the second processor 163 may control displaying identifiers or images for indicating the types of contents at or near displayed icons such that the types of contents are identified intuitively. Alternatively, the second processor 163 may control displaying contents with different sizes depending on types thereof in a content provision region. Alternatively, the second processor 163 may create thumbnails corresponding to respective contents and control displaying such thumbnails in a content provision region. These thumbnails may contain partial information about corresponding contents.

In response to an input signal generated at a content provision region, the second processor 163 may support a selection of specific content. The second processor 163 may transfer selected content to at least one of a content arrangement preparation region and a content arrangement display region. For example, in response to a touch-drag-and-release gesture, the second processor 163 may select specific content and transfer the selected content to a content arrangement preparation region and/or a content arrangement display region.

According to various embodiments of this disclosure as discussed hereinbefore, the electronic device 100 supports a simple formation of a page through selection, transfer and arrangement of contents stored in the storage module 150. Additionally, the electronic device 100 allows contents to be arranged in a user's desired form regardless of the size and number of contents. Further, the electronic device 100 supports a simple edit of an existing page through a page editor.

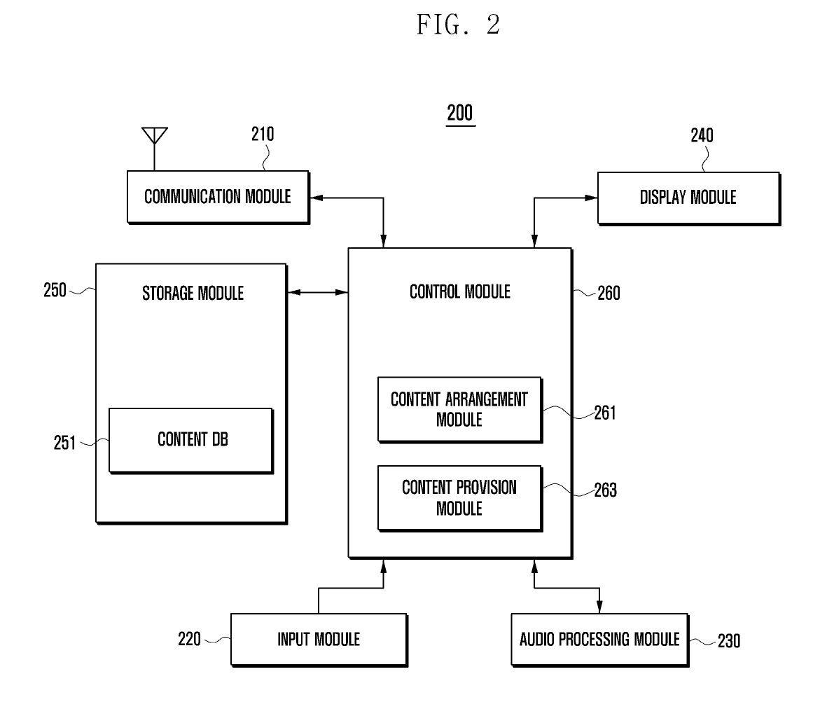

FIG. 2 is a block diagram illustrating a configuration of an electronic device according to an embodiment of the present disclosure.

The electronic device 200 shown in FIG. 2 is an example of devices that can be designed on the basis of the configuration of the electronic device 100 shown in FIG. 1. The electronic device 200 shown in FIG. 2 may include all elements of the electronic device 100 shown in FIG. 1 or have variations of some elements.

Referring to FIG. 2, the electronic device 200 may include a communication module 210, an input module 220, an audio processing module 230, a display module 240, a storage module 250, and a control module 260. An input unit of the electronic device 200 may be composed of at least one of the input module 220, the display module 240 supporting a touch function, and the audio processing module 230 supporting a voice manipulation function.

The storage module 250, the control module 260 and the display module 240 of the electronic device 200 shown in FIG. 2 may be similar in function and operation to corresponding elements shown in FIG. 1. Alternatively, the storage module 250, the control module 260 and/or the display module 240 may have partially varied or added function and operation in comparison with corresponding elements shown in FIG. 1.

The electronic device 200 may support a function of an application installed therein, e.g., a diary function, a word function, an e-book function, or the like. While performing a page formation function, the electronic device 200 supports the use of various contents. For example, the electronic device 200 may offer one or more contents stored in a content DB 251 of the storage module 250, one or more contents received through the communication module 210, and one or more contents inputted through the input unit. The electronic device 200 may adjust the overall length of a page while maintaining a space between respective contents arranged. For a search through a page greater than a screen of the display module 240, the electronic device 200 may offer a scroll function.

In an embodiment, the electronic device 200 allows the communication module 210 to transmit a page to another electronic device. Also, the electronic device 200 may receive a page containing one or more contents from another electronic device through the communication module 210. Such contents contained in the received page may be registered in the content DB 251 of the storage module 250 and used for creating or editing other page.

According to various embodiments, the electronic device 200 may support at least one of an SNS function, a call function, an SMS or MMS function, an email function, and a video call function which are offered using the communication module 210. In this operation, the electronic device 200 may collect contents and allow these contents to be used for the formation of a page. For example, the electronic device 200 may offer, as text content or video content, at least one of a chatting message, an SMS message, an MMS message, an email message, and a video message which are transmitted or received through the communication module 210. Further, the electronic device 200 may offer, as audio content, a voice signal transmitted or received through the communication module 210.

The communication module 210 may support a function of access to a server or a function of connection to another electronic device. The communication module 210 may receive various types of contents offered by a server or any other electronic device. For example, the communication module 210 may receive text contents, media contents, chart contents, and/or table contents from a server or any other electronic device. Such contents received by the communication module 210 may be stored in the content DB 251 of the storage module 250.

The communication module 210 may be removed in case the electronic device 200 fails to support a communication function. If the electronic device 200 has mobility, the communication module 210 may have the form of a mobile communication module. Additionally or alternatively, the communication module 210 may include, but not be limited to, a short-range communication module and/or a wired communication module.

The input module 220 may support the creation of a signal associated with the operation of the electronic device 200. The input module 220 may include a hardware key mechanism such as a key button, a side key, a home key, a menu key, a power key, and the like. Additionally, the input module 220 may include a touch pad or a touch sheet that generates an event caused by a touch gesture. In an embodiment, the input module 220 may create an input signal associated with a search for a page, an input signal associated with the creation of a new page, an input signal associated with the editing of a page, etc. in response to a user's manipulation. This input signal may be transmitted to the control module 260 to operate as a command associated with a corresponding function.

The audio processing module 230 may process an audio signal generated during the operation of the electronic device 200. For example, the audio processing unit 230 may include a speaker that supports the output of an audio signal generated by the playback of a specific audio file stored in the electronic device 200 or received from any external electronic device. Further, the audio processing module 230 may include a microphone that collects an audio signal in connection with a recording or call function of the electronic device 200. According to an embodiment, the audio processing module 230 may offer audio contents collected in a call function to the formation of a page. Also, the audio processing unit 230 may output an audio signal in response to the playback of audio content arranged in a specific page.

In various embodiments, the audio processing module 230 may output a notification sound or a sound effect in connection with a page editor. Additionally, the audio processing module 230 may output a notification sound or a sound effect according to selection, transfer and arrangement of contents in a content provision region. Depending on a user's setting or a designer's design scheme, the audio processing module 230 may omit or restrain the output of an audio signal.

The display module 240 may output a screen associated with the operation of the electronic device 200. For example, the display module 240 may offer an idle screen, a menu screen, an icon screen, a screen for displaying specific content, or the like. The display module 240 formed of a touch screen may be used as an input unit. The display module 240 may be formed of a display panel and a touch panel or touch sheet. The display module 240 may support a finger touch, an electronic pen touch or a normal pen touch. The display module 240 may have a plurality of touch panels or touch sheets.

In various embodiments, the display module 240 may offer a search screen for finding at least one page. Further, the display module 240 may output a page editor used to create a new page or edit a created page. The page editor may contain a content arrangement region. Depending on an input signal, the page editor may contain a content arrangement region and a content provision region. Such a content arrangement region may have at least one of a content arrangement reserve region, a content arrangement preparation region, both associated with the creation of a new page, and a content arrangement display region associated with the display of an existing page. The content provision region may have one or more contents displayed thereon. Such contents may include at least one of text contents, image contents, and audio contents, which can be applied to the formation of a page. Screens associated with the operation of the page editor will be discussed later.

The storage module 250 may store programs and data associated with the operation of the electronic device 200. For example, the storage module 250 may store an operating system, at least one application (often shortly, “app”), and the like. An operating system may perform a signal processing corresponding to an operation control of at least one application. This application may be a program corresponding to a user function offered by the electronic device 200. Further, this application may include a communication function application such as a call function application, a message service application, a data communication application for a video call or web access, an SNS support application, and the like.

In various embodiments, the storage module 250 may include the content DB 251 which stores contents therein. The content DB 251 may store at least one of text contents, image or photo contents, and audio contents transmitted or received through the communication module 210. Further, the content DB 251 may store one or more contents inputted at the time of design of the electronic device 200. Also, the content DB 251 may store text content, image content, and/or audio content, which are generated through an input unit of the electronic device 200. In case the electronic device 200 has a camera, the content DB 251 may store images collected by the camera.

Such contents stored in the content DB 251 may be classified according to their categories. For example, contents stored in the content DB 251 may include text content, media content, chart content, and table content.

Text content may be basically formed of text. According to various embodiments, text content may include text collected from a web page or document, text collected from a message, email, or the like transmitted or received through the communication module 210, and/or text formed of characters inputted through an input unit. Additionally, text content may be created by speech-to-text conversion of audio signals inputted through the audio processing module 230. In a process of forming a page, text content may be adjusted using a default size and style of font. Such a font size and style may be varied according to a user's setting.

Media content may include picture content, photo content, video content, and the like. Media content may contain therein a description or caption for explaining content. Media content may have a default size. For example, in case image content is received through the communication module 210 or in case photo content is collected through a camera, such content may be adjusted to meet a default size and then saved as media content.

Chart content may be created on the basis of plural data. For example, chart content may be represented using the ratio of individuals to a specific group or sample. Alternatively, chart content may be represented using a specific-sized image corresponding to the number or amount of individuals. Alternatively, chart content may have a graph form. Chart content may contain text for explaining a chart. If chart content is received from any external entity, the control module 260 may adjust such content to meet a default size and then store it in the content DB 251.

Table content may be created as an orderly arrangement of plural data. For example, in table content, a plurality of parameters may be disposed horizontally and vertically, and certain values may be recorded at each cross point in columns and rows. Table content may contain text for explaining such parameters. If table content is received from any external entity, the control module 260 may adjust such content to meet a default size and store it in the content DB 251.

Although it is discussed above that contents used for forming a page are text content, media content, chart content and table content, this is exemplary only and not to be considered as a limitation of the present disclosure. For example, contents that constitute a certain page may further include audio content. According to various embodiments, contents that constitute a certain page may include avatar content or character content, which operates by means of a predefined program routine.

The control module 260 may perform the processing and delivery of control signals and data in connection with the operation of the electronic device 200. In various embodiments, the control module 260 may include a content arrangement module 261 and a content provision module 263. The content arrangement module 261 may have a similar, corresponding or varied form in comparison with the first processor 161 discussed previously in FIG. 1. Similarly, the content provision module 263 may have a similar, corresponding or varied form in comparison with the second processor 163 discussed previously in FIG. 1.

The content arrangement module 261 may support the output and operation of a content arrangement region. In various embodiments, the content arrangement module 261 may output a screen containing at least one page therein to the display module 240 in response to a suitable input event. If an input event associated with the creation of a new page or the editing of a selected page occurs, the content arrangement module 261 may output a page editor to the display module 240.

The content arrangement module 261 may control the output of a page editor that contains therein at least one of a content arrangement reserve region, a content arrangement preparation region, and a content arrangement display region. In response to a suitable input event, the control arrangement module 261 may assign one or more contents offered by the content provision module 263 to a content arrangement preparation region and/or a content arrangement display region.

If an input event corresponding to the completion of a page formation happens, the content arrangement module 261 may output a page editor screen or a page search screen to the display module 240. Further, in response to a suitable input event, the content arrangement module 261 may control a change in a page screen. For example, in case a specific page is greater than a screen of the display module 240, the content arrangement module 261 may support a scroll function. If any scroll event happens, the content arrangement module 261 may move a page such that a non-displayed part of the page can be displayed on the display module 240.

The content arrangement module 261 may create and manage a content library. For example, the content arrangement module 261 may create a library of each page from a list of contents arranged in each page. When a certain page is selected, the content arrangement module 261 may refer to such a content library and thereby identify contents arranged in the selected page. If a new page is created, the content arrangement module 261 may update a content library.

The content provision module 263 may output a content provision region to the display module 240 when a content provision call event occurs in connection with a page formation. For example, the content provision module 263 may output a content provision region while a content arrangement region is outputted to a page editor. In this operation, the content provision module 263 may perform the division and resizing of a screen so as to output a content arrangement region and a content provision region together. Alternatively, the content provision module 263 may overlay a content provision region on a content arrangement region. Further, the content provision module 263 may output a content provision region so as not to overlap with a content arrangement preparation region in a content arrangement region. For example, in case a plurality of content arrangement preparation regions are displayed, the content provision module 263 may adjust the size and/or position of a content provision region such that at least one of the content arrangement preparation regions may not be overlapped with the content provision region.

The content provision module 263 may control a process of offering one or more contents. For example, the content provision module 263 may classify contents according to their categories, e.g., text, media, chart and table. The content provision module 263 may offer contents classified by categories through separate pages. Alternatively, the content provision module 263 may display one or more contents in a content provision region through a unified content search screen without classification based on categories.

In various embodiments, the content provision module 263 may output a virtual content search button to the display module 240. If this button is executed, the content provision module 263 may output, to the display module 240, at least one of specific content stored in the storage module 250 and specific content offered by a server in response to a search keyword. Then, if the latter content is selected to form a page, the content provision module 263 may store the selected content in the content DB 251.

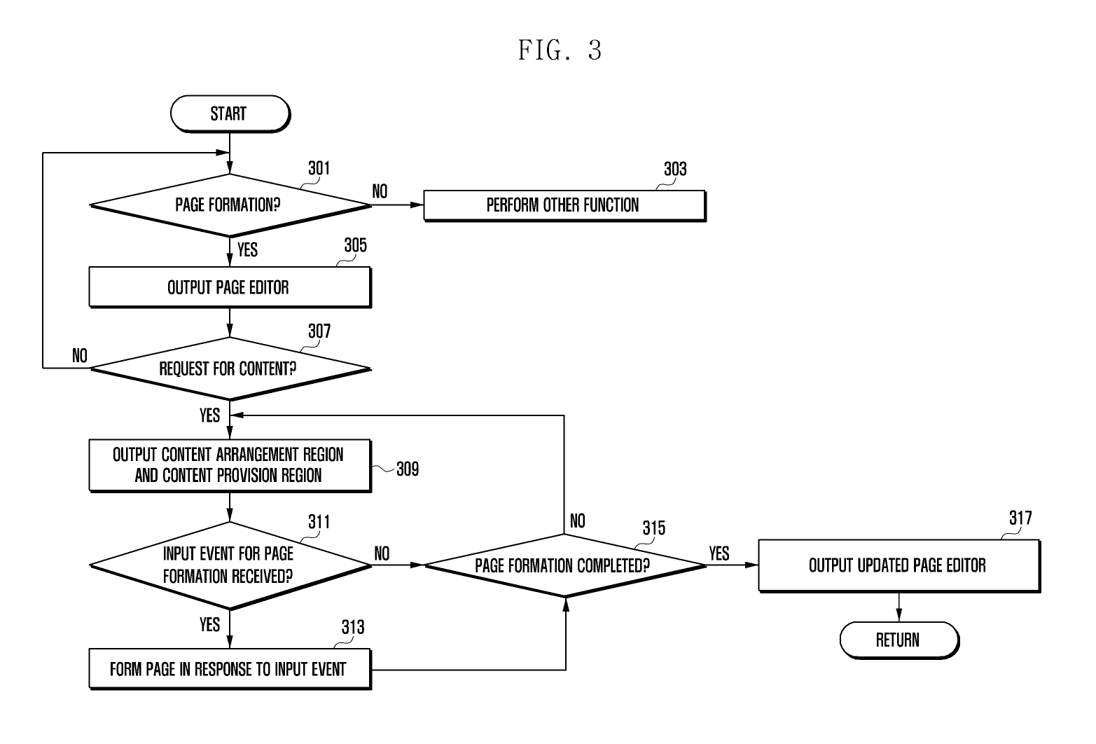

FIG. 3 is a flow diagram illustrating a method for operating an electronic device in connection with the formation of a page according to an embodiment of the present disclosure. This electronic device may be either the electronic device 100 of FIG. 1 or the electronic device 200 of FIG. 2. In the following description, the electronic device 200 is used exemplarily.

Referring to FIG. 3, at operation 301, the control module 260 of the electronic device 200 may determine whether an input event associated with the formation of a page happens. If any input event which is not associated with a page formation occurs at operation 301, the control module 260 may perform a particular function corresponding to the input event at operation 303. In various embodiments, the control module 260 may control a file playback function, a broadcast reception function, a file search function, an image edit function, etc. of the electronic device 200 in response to the input event. Alternatively, the control module 260 may control the reception of contents using the communication module 210 in response to the input event.

Before operation 301, the control module 260 may control the output of a screen that contains at least one page. For example, the control module 260 may output a screen containing therein icons, each of which corresponds to a document. This document may be content having at least one page. Additionally, the control module 260 may output, to the display module 240, a page search screen that contains therein a plurality of pages of a specific document.

If an input event associated with a page formation occurs at operation 301, the control module 260 may output a page editor to the display module 240 at operation 305. This page editor may involve a content arrangement region associated with a page formation. The content arrangement region may include at least one of a content arrangement display region in which a page is formed of one or more contents arranged in advance, a content arrangement preparation region which is activated for arrangement of one or more contents, and a content arrangement reserve region which supports the creation of a new page.

At operation 307, the control module 260 may determine whether an input event associated with a request for content occurs. For this, the control module 260 may offer a specific icon and/or menu item to be used for generating an input event of a content request. Additionally or alternatively, the control module 260 may recognize a touch event generated on a content arrangement preparation region as an input event of a content request. If an input event that occurs at operation 307 is a return command, the control module 260 may return to the aforesaid operation 301.

If an input event associated with a content request occurs at operation 307, the control module 260 may output a screen containing a content arrangement region and a content provision region to the display module 240 at operation 309. The content provision region may contain therein at least one of text content, image content, and audio content. Additionally, the content provision region may contain therein various types of contents displayed together in a single region. Further, the content provision region may contain therein various types of contents classified and displayed according to predefined categories.

At operation 311, the control module 260 may determine whether an input event associated with the formation of a page occurs. If so, the control module 260 may control a process of forming a page in response to an input signal at operation 313. According to various embodiments, in response to a suitable input event, the control module 260 may arrange one or more contents from a content provision region to a content arrangement preparation region and/or a content arrangement display region. Additionally, in response to a suitable input event, the control module 260 may remove one or more contents from a content arrangement preparation region and/or a content arrangement display region. Also, in response to a suitable input event, the control module 260 may remove a content arrangement display region. Also, in response to a suitable input event, the control module 260 may activate a content arrangement reserve region and convert it into a content arrangement preparation region. Further, in response to a suitable input event, the control module 260 may control a change of positions between a content arrangement display region and a content arrangement preparation region. If displaying a content arrangement region, the control module 260 may control displaying the type and number of contents assigned respectively to a content arrangement preparation region and a content arrangement display region. Further, at this operation, the control module 260 may control displaying the order of contents assigned to a content arrangement preparation region and a content arrangement display region.

If an input event is not associated with the formation of a page at operation 311, the control module 260 may further determine at operation 315 whether the input event is associated with the completion of a page formation. In case of no completion, the control module 260 may return to operation 309.

If an input event for the completion of a page formation occurs at operation 315, the control module 260 may support the output of an updated page editor at operation 317. This updated page editor may convert a content arrangement preparation region having assigned contents into a content arrangement display region. The updated page editor may be configured to have a content arrangement region. When the updated page editor is outputted, the control module 260 may remove a content provision region from the display module 240. Also, the control module 260 may offer the updated page editor in the form of a page search screen.

Thereafter, depending on an input event, the control module 260 may return to operation 301 or operation 305. For example, the control module 260 may return to operation 301 in response to an input event associated with the finish of a page editor. Additionally, the control module 260 may return to operation 305 in response to an input event corresponding to the output of an initial screen of a page editor.

As discussed hereinbefore, various embodiments of this disclosure provide techniques to arrange various contents in a single page without consideration for the size or amount of such contents. Further, various embodiments of this disclosure provide techniques to simply manipulate the arrangement, edit, rearrangement, etc. of contents by using a content provision region.

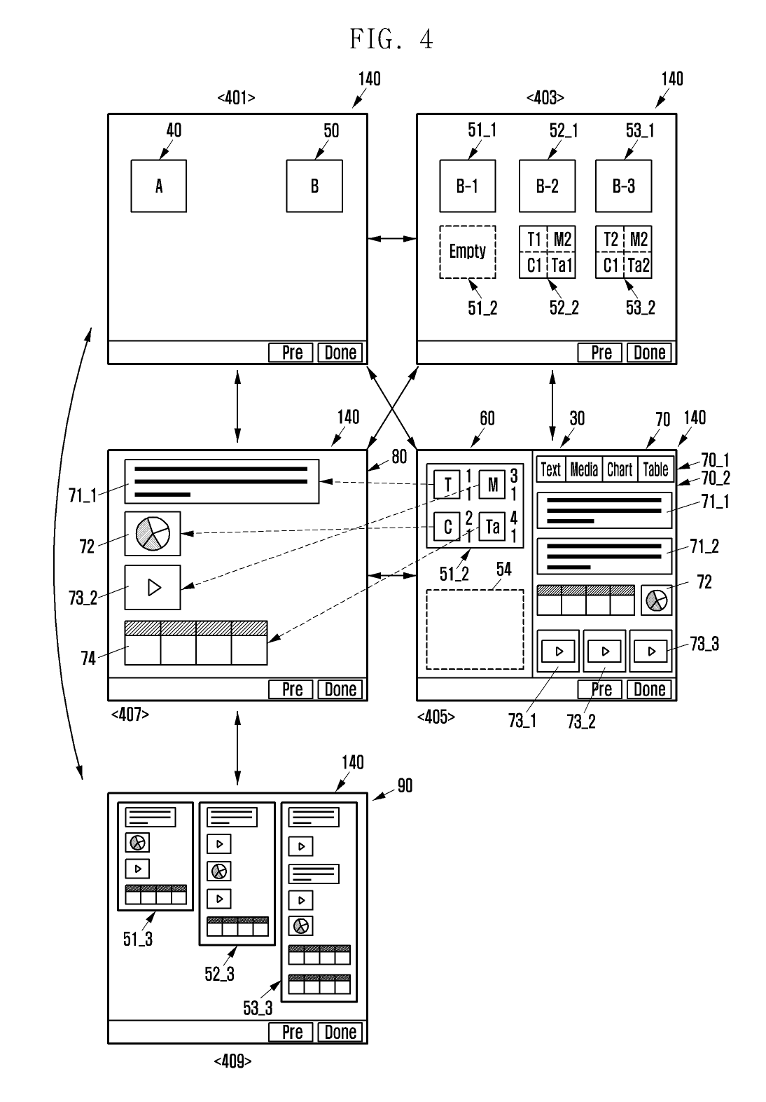

FIG. 4 is a schematic diagram illustrating formation of a page according to an embodiment of the present disclosure. Although various embodiments of this disclosure employ the term “page”, this is exemplary only and not to be considered as a limitation of this disclosure. The term “page” may be often regarded as “slide”, “thread”, or any other equivalent. Also, the following description refers to elements of the electronic device 100 of FIG. 1. However, this is only an example and the description may also apply to the electronic device 200 of FIG. 2 or another electronic device.

Referring to FIG. 4, the display module 140 of the electronic device 100 may output a screen that contains at least one document icon or page icon as shown in a screenshot 401. In the following description, icons 40 and 50 shown in the screenshot 401 will be regarded as document icons, each of which contains at least one page. The display module 140 may display an idle screen as shown in the screenshot 401. Alternatively, when a menu or icon corresponding to a document item is selected, the display module 140 may output a screen having the document icons 40 and 50 as shown in the screenshot 401.

If an input event for selecting the document icon 50 occurs on a screen as shown in the screenshot 401, the display module 140 may output thereon a page formation screen corresponding to the selected document icon 50 under the control of the control module 160 as shown in a screenshot 403. This page formation screen may contain at least one page arranged therein, e.g., the first, second and third pages as shown. Alternatively, the page formation screen may have parts of much more pages to be arranged therein. Although a screen shown in the screenshot 403 has three pages, this is exemplary only and not to be considered as a limitation of this disclosure. Depending on the selected document icon, the page formation screen may have a page or pages more than or less than three. In case there are many pages, the display module 140 may support a scroll function. Further, if such pages are displayed in a matrix form, the display module 140 may support horizontal, vertical and diagonal scroll functions.

The page formation screen shown in the screenshot 403 contains the first, second and third page thumbnails 51-1, 52-1 and 53-1 and the first, second and third formation maps 51-2, 52-2 and 53-2. The page thumbnails 51-1, 52-1 and 53-1 indicate three pages. In various embodiments, the control module 160 may store and manage thumbnails having a reduced size of pages. Based on such thumbnails, the control module 160 may construct the page formation screen 403.

The first, second and third formation maps 51-2, 52-2 and 53-2 indicate the formation of contents assigned to real pages of the first, second and third page thumbnails 51-1, 52-1 and 53-1, respectively. For example, the second formation map 52-2 indicates that a page corresponding to the second page thumbnail 52-1 contains single text content, two media contents, single chart content, and single table content. Similarly, the third formation map 53-2 indicates that a page corresponding to the third page thumbnail 53-1 contains two text contents, two media contents, single chart content, and two table contents. Also, the first formation map 51-2 indicates that no content is assigned to the first page thumbnail 51-1.

When the first formation map 51-2 is selected, the control module 160 may call a page editor. As shown in a screenshot 405, the display module 140 may output a page editor screen 30 that contains a content arrangement region 60 and a content provision region 70. Alternatively, the display module 140 may output first a screen having the content arrangement region 60 only and, in response to an input event, may further output the content provision region 70.

The content arrangement region 60 may have a content arrangement preparation region 51-2 for assigning contents thereto in connection with the formation of the first page, and a content arrangement reserve region 54 for adding a new page. Additionally, the content arrangement region 60 may have the second and third formation maps 52-2 and 53-2 as a content arrangement display region. Such a content arrangement display region may, however, be removed from the display module 140 due to a limitation in size of the content arrangement region 60. If a scroll event happens, the display module 140 may display a content arrangement display region that corresponds to at least one of the second and third formation maps 52-2 and 53-2.

The content provision region 70 may contain one or more contents therein. For example, the content provision region 70 may have a content classification tab region 70-1 and a content display region 70-2.

The content classification tab region 70-1 may have category tabs of contents classified and stored in the content DB 151. For example, the content classification tab region 70-1 may have a text category tab, a media category tab, a chart category tab, and a table category tab. Each section may be offered as a virtual key button. If any virtual key button of the text tab is selected, the content display region 70-2 may display text contents. Similarly, if a key button of the chart tab is selected, the content display region 70-2 may display chart contents. Respective tabs of the content classification tab region 70-1 may be varied according to a change in categories. For example, depending on a change in categories, the number of tabs in the content classification tab region 70-1 may increase or decrease.

The content display region 70-2 may display one or more contents. For example, the content display region 70-2 may display text contents 71-1 and 71-2, chart content 72, media contents 73-1, 73-2 and 73-3, and table content 74, each of which has a default-sized image. The content display region 70-2 may display various types of contents together. Alternatively, the content display region 70-2 may display contents corresponding to a specific tab selected from the content classification tab region 70-1. For example, if a virtual key button of a text tab is selected from the content classification tab region 70-1, the content display region 70-2 may display text contents 71-1 and 71-2 only. Although FIG. 4 shows that limited contents are arranged in the content display region 70-2, this is exemplary and not to be considered as a limitation of this disclosure. The content display region 70-2 may be constructed so as to be scrolled. If a scroll event happens, non-displayed contents may appear in the content display region 70-2.

In order to form the first page, desired contents are selected from the content display region 70-2 and then moved to the content arrangement preparation region 51-2. For example, text content 71-1 arranged in the content display region 70-2 may be selected by means of an input event. In an embodiment, the selected text content 71-1 may be assigned to the content arrangement preparation region 51-2 by means of a drag-and-drop event. The content arrangement preparation region 51-2 may represent a state where single text is assigned. Similarly, chart content 72, media content 73-2 and table content 74 may be arranged respectively in the content arrangement preparation region 51-2.

The content arrangement preparation region 51-2 may offer information about the arrangement order of contents. For example, in case text content 71-1, chart content 72, media content 73-2 and table content 74 are assigned in sequence, the content arrangement preparation region 51-2 may display information about the order of such assignment. Further, the content arrangement preparation region 51-2 may display information about the number of contents according to their categories. If two or more contents having the same category are arranged together, the content arrangement preparation region 51-2 may also display information about the order of such contents.

When an input event associated with the completion of a page formation happens, for example, if a virtual key button “Done” is selected, the display module 140 may output a page display screen 80 as shown in a screenshot 407. The page display screen 80 may display selected contents according to the order and type of contents arranged in the content arrangement preparation region 51-2. For example, the page display screen 80 may arrange text content 71-1, chart content 72, media content 73-2 and table content 74 from the top to the bottom. If an input event for returning to a previous state happens, the control unit 160 may control a return to the previous screen as shown in the screenshot 405. At a screen shown in the screenshot 405, the display module 140 supports the edit of the content arrangement preparation region 51-2. Depending on the type of an input event, the control module 160 may control a return to a further previous screen as shown in the screenshot 403.

If an input event for returning to the screenshot 403 from the screenshot 407 happens, the display module 140 may display the first formation map 51-2 to contain contents assigned in a state shown in the screenshot 405. Namely, this formation map 51-2 may have single text content, single media content, single chart content, and single table content.

If a specific input event occurs at a state shown in the screenshot 407, the display module 140 may output a page search screen 90 as shown in a screenshot 409. The page search screen 90 may display the first, second and third pages 51-3, 52-3 and 53-3. If an input event for selecting one of such pages occurs, the display module 140 may display the selected page as a full screen. For example, the display module 140 may display a full screen of the first page 51-3 as shown in the screenshot 407.

In an embodiment, the second page 52-3 may be greater in size than the first page 51-3. In this case, the display module 140 may display a part of the second page 52-3 as a full screen. The other part of the second page 52-3 may be displayed in response to a scroll event. Similarly, the display module 140 may display a part of the third page 53-3 and, in response to a scroll event, display the other part.

Meanwhile, going to the previous or next screen may be performed in response to the input of a specific button. This is, however, exemplary only and not to be considered as a limitation of this disclosure. Alternatively, a shift between screens may be performed in response to a specific event. For example, if a leftward sweep event occurs in a state of the screenshot 405, the display module 140 may display a screen as shown in the screenshot 407. Additionally, if a rightward sweep event occurs in a state of the screenshot 405, the display module 140 may display a screen as shown in the screenshot 403.

Like this, the display module 140 may support a shift between screens as shown in the screenshots 401, 403, 405, 407 and 409 when a suitable input event happens. Further, such a shift of screens may depend on a designer's intention or user's setting.

In an embodiment, the control module 160 may offer a menu for selecting one of the page formation screen, the page editor screen 30, the page display screen 80, and the page search screen 90. If a specific item of menu is selected, the control module 160 may output a specific screen corresponding to the selected item to the display module 140.

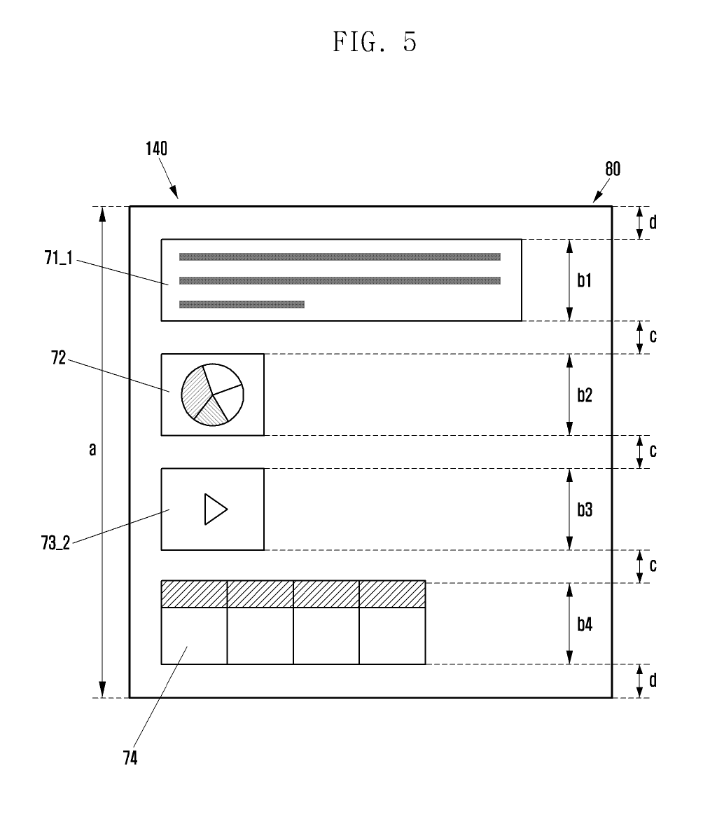

FIG. 5 is a schematic diagram illustrating a layout of a page according to an embodiment of the present disclosure.

Referring to FIG. 5, the display module 140 may display respective contents at specific positions in the page display screen 80. For example, text content 71-1 may be displayed to have a thickness b1. Similarly, chart content 72, media content 73-2 and table content 74 may be displayed to have thicknesses b2, b3 and b4, respectively. Additionally, the first content, e.g., text content 71-1, may be separate and apart from the top of a page by a specific distance “d”. Similarly, the last content, e.g., table content 74, may be separate apart from the bottom of a page by a specific distance “d”.

In the page display screen 80 as shown in FIG. 4, adjacent contents may be disposed to have a specific space “c”. Namely, a space between text content 71-1 and chart content 72 may be equal to a space between chart content 72 and media content 73-2.

The thickness b1 of text content 71-1 may be determined depending on the size of text content 71-1. If another text content 71-2 has a different-sized amount of contents in comparison with text content 71-1, text content 71-2 may be disposed on the page display screen 80 while having a thickness different from the thickness b1. Similarly, chart content 72 may be varied in thickness according to the size thereof. Alternatively, chart content 72 may have an unvaried thickness. If any chart content has a different size, the control module 160 may adjust the size of the chart content to a predefined size and dispose it on the page display screen 80. Media content and table content may also be outputted on the page display screen 80 at a predefined thickness. If an input event for changing the size of content happens, the display module 140 may display such content with a changed thickness and size.

In case the total size or amount of contents is changed, the page display screen 80 may change the overall length “a”. For example, if the size or amount of contents arranged in the page display screen 80 is smaller than a given threshold, the page may have a relatively smaller overall length. In contrast, if the size or amount of contents arranged in the page display screen 80 is greater than a given threshold, the page may have a relatively greater overall length.

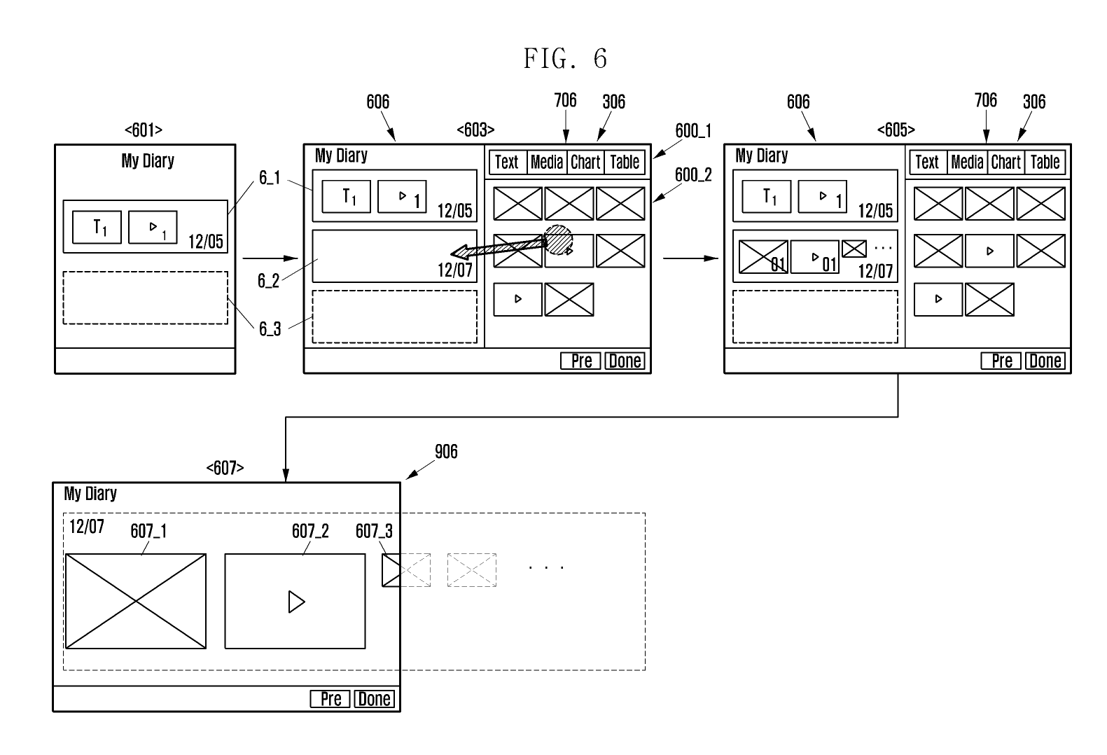

FIG. 6 is a schematic diagram illustrating formation of a diary page according to an embodiment of the present disclosure.

Referring to FIG. 6, when an input event associated with the formation of a diary page happens, the display module 140 may output a diary page formation screen having diary content arrangement regions as shown in a screenshot 601. The diary page formation screen may have a diary page display region 6-1 and a diary page reserve region 6-3. The diary page display region 6-1 may correspond to a diary page that contains already assigned contents therein. For example, the diary page display region 6-1 may indicate a state in which single text content and single media content have been assigned on December 5. The diary page reserve region 6-3 may be used for creating a new diary page.

If an input event for selecting the diary page reserve region 6-3 or requesting the creation of a new diary page happens, the display module 140 may output a diary page editor screen 306 as shown in a screenshot 603.

The diary page editor screen 306 may contain a diary content arrangement region 606 and a diary content provision region 706. The diary content arrangement region 606 may have a diary page display region 6-1, a diary page preparation region 6-2, and a diary page reserve region 6-3. The diary page display region 6-1 and the diary page reserve region 6-3 may be the same as discussed above in the screenshot 601.

One or more contents arranged in the diary content provision region 706 may be assigned to the diary page preparation region 6-2 which supports the creation of a new diary page.

The diary content provision region 706 may contain one or more contents outputted in the form of a default-sized image or icon. Contents arranged in the diary content provision region 706 may include various contents collected during the operation of the electronic device 100. The diary content provision region 706 may have a diary content classification tab region 600-1 and a diary content display region 600-2.

The diary content classification tab region 600-1 may display category tabs associated with classification of one or more contents. For example, the diary content classification tab region 600-1 may have a text category tab, a media category tab, a chart category tab, and a table category tab. In an embodiment, the diary content classification tab region 600-1 may include a text message tab, a media data tab for indicating images, photos or videos, a schedule tab, a memorial day tab, and the like. Respective tabs of the diary content classification tab region 600-1 may be varied according to a user's setting or manipulation.

The diary content display region 600-2 may display one or more contents associated with the formation of a diary page. For example, the diary content display region 600-2 may display various date-related contents such as message content, chatting message content, email content, call log content, video call log content, and schedule content. The diary content display region 600-2 may display contents corresponding to a specific tab selected from the diary content classification tab region 600-1. In an embodiment, the diary content display region 600-2 may display various contents on the basis of date. For example, as shown in a screenshot 603, various contents generated, transmitted or received on December 7 such as a message, a voice call, a video call, received data, and the like may be offered to the diary content display region 600-2. A desired one or more of contents arranged in the diary content display region 600-2 may be assigned to a specific date in the diary content arrangement region 606 by means of a touch-drag-and-drop. For example, contents in the diary content display region 600-2 may be assigned to the diary page display region 6-1 and/or the diary page preparation region 6-2. For example, as shown in a screenshot 605, the display module 140 may assign one message content, one media content, and another message content to the diary page preparation region 6-2.

If an event for finishing a page formation happens, the control module 160 may create a new diary page through the diary page preparation region 6-2. As shown in a screenshot 607, the display module 140 may display a diary page search screen 906 for a search for a new diary page. The diary page search screen 906 may have arrangement of one message content 607-1, one media content 607-2, and another message content 607-3, which are assigned to a specific date, e.g., December 7. In this case, one message content 607-1 may be text message content, and another message content 607-3 may be text content that contains at least part of a chatting message. Media content 607-2 may be a transmitted or received photo or image, a recorded log of video call, or an image or video received from a server.

If the diary page search screen 906 fails to display all contents contained in a single diary page, the display module 140 may output only a part of the diary page as a full screen. Then the display module 140 may display the other part in response to a sweep or scroll event.

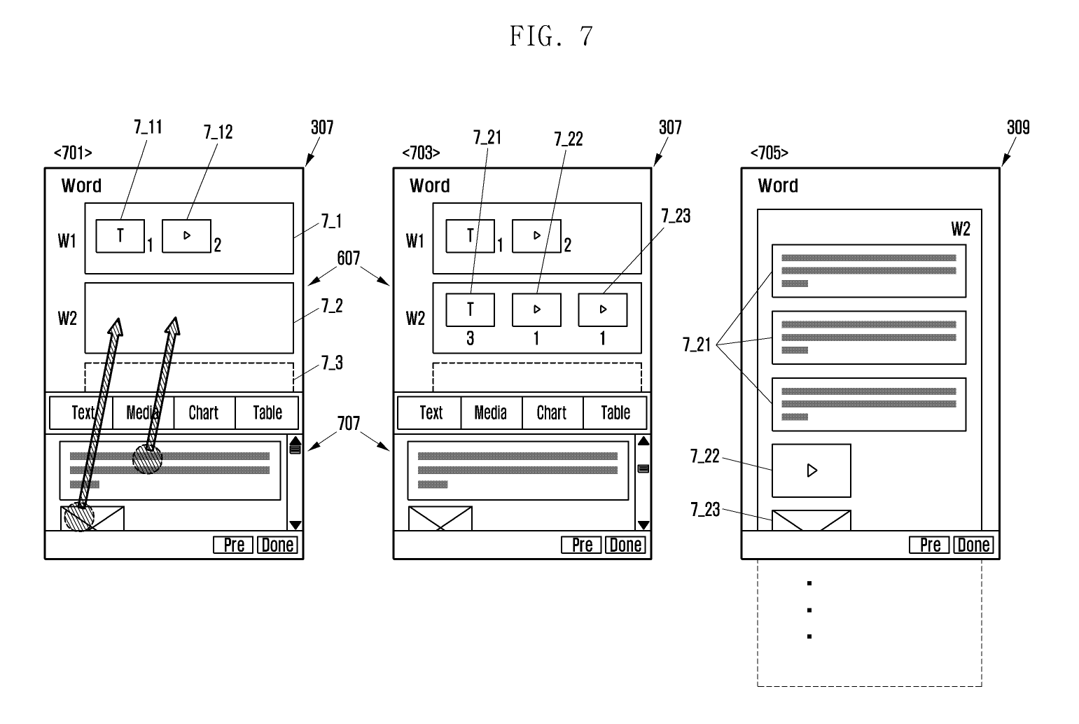

FIG. 7 is a schematic diagram illustrating formation of a word page according to an embodiment of the present disclosure.

Referring to FIG. 7, when an input event associated with the formation of a word page, the display module 140 may output a word page editor screen 307 as shown in a screenshot 701. Before this output of the word page editor screen 307, the display module 140 may output a word page formation screen in which already created word pages are arranged. If there is no already created word page, the display module 140 may output the word page editor screen 307 in response to an input event. The word page editor screen 307 may contain therein a word content arrangement region 607 and a word content provision region 707.

The word content arrangement region 607 may have a word page display region 7-1, a word page preparation region 7-2, and a word page reserve region 7-3.

The word page display region 7-1 may display a word page to which contents are assigned. For example, the first word page corresponding to the word page display region 7-1 may have the arrangement of single text content 7-11 and two media contents 7-12. The word page display region 7-1 may further have contents arranged in the word content provision region 707 in response to a suitable input event. Also, any content may be removed from the word page display region 7-1 in response to a suitable input event.

One or more contents arranged in the word content provision region 707 may be assigned to the word page preparation region 7-2 which corresponds to a new word page. For example, the word page preparation region 7-2 may correspond to the second word page newly created.

The word page reserve region 7-3 may support the creation of a new word page. If a touch event occurs on the word page reserve region 7-3, the control module 160 may create another word page preparation region 7-2. When the word page reserve region 7-3 is changed to another word page preparation region 7-2, the third word page may be created. Further, the control module 160 may create a new word page reserve region which corresponds to the creation of the fourth word page.

The word content provision region 707 may have various contents arranged therein and to be applied to the creation of a word page. For example, the word content provision region 707 may contain text content, message content, media content, chart content, table content, and the like. Certain content arranged in the word content provision region 707 may be assigned to the word page preparation region 7-2 and/or the word page display region 7-1 in response to a touch event. Further, the word content provision region 707 may be scrolled. When a scroll event happens, the word content provision region 707 may newly display contents which are not currently displayed. In an embodiment, as shown in a screenshot 703, three text contents 7-21, single media content 7-22, single message content 7-23, etc. arranged in the word content provision region 707 may be assigned to the word page preparation region 7-2 in response to a touch event.

If an input event for requesting a shift to a page search screen occurs after assignment of contents in the word page preparation region 7-2, the display module 140 may output a word page search screen 309 as shown in a screenshot 705. The word page search screen 309 may output the second word page W2, for example. The second word page W2 may have the arrangement of three text contents 7-21, single media content 7-22, single message content 7-23, etc. If contents constituting the second word page W2 are greater in amount than contents displayed on a predefined screen of the display module 140, only parts of contents of the second word page W2 may be outputted to the display module 140. In this case, a scroll function may be offered for the second word page W2. Any non-displayed part of the second word page W2 may be outputted to the display module 140 in response to a scroll event.

Meanwhile, if an input event for requesting a page shift happens, the display module 140 may output the first word page which may contain, for example, single text content and two media contents. If the total size or amount of these contents does not exceed a default size or amount, all contents may be displayed in a full screen.

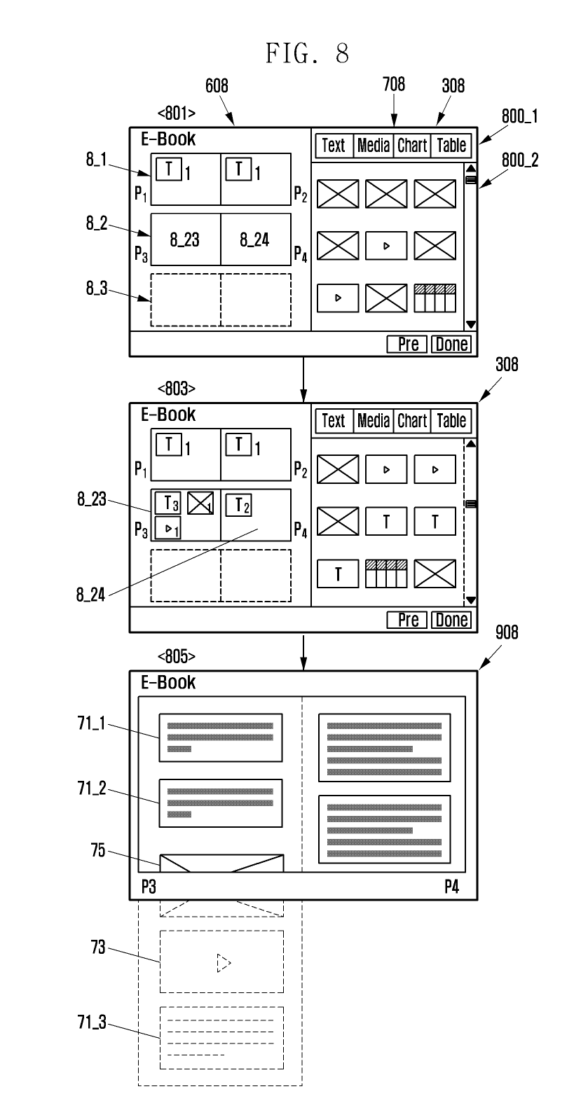

FIG. 8 is a schematic diagram illustrating formation of an e-book page according to an embodiment of the present disclosure.

Referring to FIG. 8, if an input event associated with the formation of an e-book page happens, the display module 140 may output an e-book page editor screen 308 as shown in a screenshot 801. In an embodiment, if an input event associated with the formation of an e-book page occurs on a screen having e-book icons or in a state of executing e-book content, the display module 140 may output the e-book page editor screen 308.

The e-book page editor screen 308 may contain an e-book content arrangement region 608 and an e-book content provision region 708. The display module 140 may divide a screen and dispose such regions 608 and 708 at the divided screen.

The e-book content arrangement region 608 may have at least one of an e-book page display region 8-1, an e-book page preparation region 8-2, and an e-book page reserve region 8-3. In connection with assignment of contents arranged in the e-book content provision region 708, the e-book page display region 8-1 and the e-book page preparation region 8-2 may be displayed on the e-book content arrangement region 608. The e-book page reserve region 8-3 associated with the creation of a new e-book page may be omitted. The display module 140 may display a virtual key button associated with the creation of a new e-book page at a certain position. Alternatively, the control module 160 may output a menu associated with the creation of a new e-book page in response to a suitable input event. The e-book content arrangement region 608 may offer the e-book page display region 8-1 and the e-book page preparation region 8-2 in the form of two pages assigned to a single screen.

The e-book content provision region 708 may have the arrangement of contents to be assigned to at least one of the e-book page display region 8-1 and the e-book page preparation region 8-2. For example, the e-book content provision region 708 may output one or more contents stored in the storage module 150, one or more contents received from a server or any other electronic device through a communication module, and the like. Such contents may be text content, media content, chart content, table content, message content, and the like. The e-book content provision region 708 may include an e-book content classification tab region 800-1 and an e-book content display region 800-2. If any classification tab is selected from the e-book content classification tab region 800-1, the e-book content display region 800-2 may output selected contents corresponding to the selected classification tab. Alternatively, the e-book content display region 800-2 may display various types of contents together. The e-book content provision region 708 may be scrolled. Non-displayed contents may be outputted to the e-book content provision region 708 in response to a scroll event.

Contents assigned to the e-book content provision region 708 may be arranged in at least one of the e-book page display region 8-1 and the e-book page preparation region 8-2. For example, at least parts of contents arranged in the e-book content provision region 708 may be assigned respectively to a certain region 8-23 corresponding to the third e-book page and another region 8-24 corresponding to the fourth e-book page among the e-book page preparation region 8-2 in response to an input event. As shown in a screenshot 803, three text contents, single message content, and single media content may be assigned to a region 8-23 corresponding to the third e-book page. Meanwhile, two text contents may be assigned to a region 8-24 corresponding to the fourth e-book page.

If an input event for calling an e-book page search screen 908 occurs on the e-book page editor screen 308, the display module 140 may output the e-book page search screen 908 as shown in a screenshot 805. This screenshot 805 shows the third e-book page P3 and the fourth e-book page P4. Meanwhile, the display module 140 may output only parts of contents arranged in the third e-book page P3. For example, referring to the screenshot 805, the third e-book page P3 may contain three text contents 71-1, 71-2 and 71-3, single message content 75, and single media content 73 arranged therein. The total amount of such contents assigned to the third e-book page P3 may be greater than the amount of contents to be outputted on a single screen of the display module 140. In this case, the third e-book page P3 may be scrolled. If any scroll event occurs on the third e-book page P3, the display module 140 may display non-displayed contents of the third e-book page P3. Meanwhile, two text contents assigned to the fourth e-book page P4 may be outputted on a single screen of the display module 140. Therefore, the fourth e-book page P4 may not support a scroll function.

When an input event for requesting a page shift happens, the display module 140 may output the first and second e-book pages together on a single screen. In this case, single text content may be disposed on each of the first and second e-book pages. If this text content assigned to the first or second e-book page is greater than a single screen of the display module 140, such a page may support a scroll function.

Regarding each of e-book contents or each of e-book pages, the control module 160 may create a content library for supporting the management of contents assigned to e-book pages. The control module 160 may store the created content library in the storage module 150.

In the above description, contents arranged in the content provision region are moved and assigned to the content arrangement region. This is, however, exemplary only and not to be considered as a limitation of this disclosure. Alternatively, the control module 160 may support the creation and edit of contents on the content provision region. For example, the control module 160 may launch a text writing window on the content provision region. Additionally, to support writing text, the control module 160 may output a virtual keypad on the display module 140. Similarly, the control module 160 may offer a suitable content editor for chart content, table content, photo content, etc. on the content provision region. Therefore, a user can modify content and assign the modified content to the content arrangement region. If any content is modified, the control module 160 may register the modified content as new content in the content provision region so as to maintain original content. Further, the control module 160 may selectively remove content from the content provision region in response to a suitable input event.

According to various embodiments of this disclosure, the formation of a page may be simplified and performed quickly. Additionally, the arrangement, adjustment, and browsing of contents may be performed effectively. Further, the uniformity of layout may be offered to documents or pages.

It will be appreciated that various embodiments of the present disclosure according to the claims and description in the specification can be realized in the form of hardware, software or a combination of hardware and software.

Any such software may be stored in a non-transitory computer readable storage medium. The non-transitory computer readable storage medium stores one or more programs (software modules), the one or more programs comprising instructions, which when executed by one or more processors in an electronic device, cause the electronic device to perform a method of the present disclosure.

Any such software may be stored in the form of volatile or non-volatile storage such as, for example, a storage device like a Read Only Memory (ROM), whether erasable or rewritable or not, or in the form of memory such as, for example, Random Access Memory (RAM), memory chips, device or integrated circuits or on an optically or magnetically readable medium such as, for example, a Compact Disk (CD), Digital Versatile Disc (DVD), magnetic disk or magnetic tape or the like. It will be appreciated that the storage devices and storage media are various embodiments of non-transitory machine-readable storage that are suitable for storing a program or programs comprising instructions that, when executed, implement various embodiments of the present disclosure. Accordingly, various embodiments provide a program comprising code for implementing apparatus or a method as claimed in any one of the claims of this specification and a non-transitory machine-readable storage storing such a program.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A page formation method comprising:
outputting a content arrangement region and a content provision region having one or more contents contained therein;
assigning at least one of the contents contained in the content provision region to the content arrangement region; and
forming a page by arranging the at least one content assigned to the content arrangement region according to a predefined size.

2. The method of claim 1, wherein the outputting of the regions includes:
outputting a page preparation region corresponding to a new page.

3. The method of claim 2, wherein the outputting of the regions further includes at least one of:
outputting a page display region to which one or more contents are assigned; and
outputting a page reserve region used for creation of a new page.

4. The method of claim 1, wherein the assigning of the at least one of the contents is performed in response to a touch event for selecting the at least one of the contents contained in the content provision region, a drag event for moving the selected content, and a drop event for disposing the moved content on the content arrangement region.

5. The method of claim 1, wherein the forming of the page includes:
adjusting the overall length of the page depending on the total size of the contents.

6. The method of claim 1, further comprising:
displaying information about the type and number of the assigned contents.

7. The method of claim 1, further comprising:
displaying information about the arrangement order of the assigned contents.

8. The method of claim 1, further comprising:
outputting the page, wherein the outputting of the page comprises:
if the contents assigned to the page are greater in amount or size than contents to be displayed on a predefined single screen of a display module, outputting parts of the contents assigned to the page to the display module; and
applying a scroll function to the page.

9. The method of claim 1, further comprising:
outputting two or more pages on a single screen,
wherein at least one of the pages has a different overall length in comparison with the other pages, depending on the size of contents assigned to each page.

10. The method of claim 1, further comprising:
creating a content library corresponding to the contents assigned to the page; and
storing the content library in a storage module.

11. An electronic device for supporting a page formation, the device comprising:
a display module configured to output a content arrangement region and a content provision region having one or more contents contained therein; and
a control module configured to assign at least one of the contents contained in the content provision region to the content arrangement region in response to an input event, and to form a page by arranging the at least one content assigned to the content arrangement region according to a predefined size.

12. The electronic device of claim 11, wherein the display module is further configured to output a page preparation region corresponding to a new page.

13. The electronic device of claim 12, wherein the display module is further configured to output at least one of a page display region to which one or more contents are assigned, and a page reserve region used for creation of a new page.

14. The electronic device of claim 11, wherein the display module is further configured to create a touch event for selecting the at least one of the contents contained in the content provision region, a drag event for moving the selected content, and a drop event for disposing the moved content on the content arrangement region.

15. The electronic device of claim 11, wherein the control module is further configured to adjust the overall length of the page depending on the total size of the contents.

16. The electronic device of claim 11, wherein the display module is further configured to display information about the type and number of the assigned contents.

17. The electronic device of claim 11, wherein the display module is further configured to display information about the arrangement order of the assigned contents.

18. The electronic device of claim 11, wherein the control module is further configured to, if the contents assigned to the page are greater in amount or size than contents to be displayed on a predefined single screen of a display module, output parts of the contents assigned to the page to the display module, and to apply a scroll function to the page.

19. The electronic device of claim 11, wherein the control module is further configured to output two or more pages on a single screen such that at least one of the pages has a different overall length in comparison with the other pages, depending on the size of contents assigned to each page.

20. The electronic device of claim 11, further comprising:
a storage module configured to store a content library corresponding to the contents assigned to the page.
